(19) United States
(12) Patent Application Publication
(10) Pub. No.: US 2026/0187413 A1
(43) Pub. Date: Jul. 2, 2026

(54) Methods, Systems, and Computer-readable Media for Training Document Type Prediction Models, and Use Thereof for Creating Accounting Records

(71) Applicant: Xero Limited, Te Aro, Wellington (NZ)

(72) Inventors: Soon-Ee Cheah, Te Aro, Wellington (NZ); Leah Weiner, Te Aro, Wellington (NZ); Muhammed Anwar, Te Aro, Wellington (NZ); Holly Xie, Te Aro, Wellington (NZ); Khantil Desai, Te Aro, Wellington (NZ)

(21) Appl. No.: 19/105,209

(22) PCT Filed: Aug. 21, 2023
(86) PCT No.: PCT/NZ2023/050084

§ 371 Date: Feb. 20, 2025

(30) Foreign Application Priority Data
Aug. 23, 2022 (AU) 2022902412
Nov. 11, 2022 (AU) 2022903391

(51) Int. Cl. G06N 3/0442; G06Q 40/12

(52) U.S. Cl. CPC G06N 3/0442; G06Q 40/12

(57) ABSTRACT

Methods are described that include: determining a candidate document associated with a user of an accounting system; providing the candidate document to a numerical representation generation model to generate a numerical representation of the candidate document; and providing the numerical representation to a document type attribute predictor to generate a predicted document type. The document type attribute predictor is configured to classify the document as one of a plurality of accounting document types.

### TECHNICAL FIELD

Embodiments generally relate to methods, systems, and computer-readable media for training a document type prediction model, and use thereof for creating accounting records.

### BACKGROUND

Creating accounting records can be an arduous and time-consuming process. It is therefore desirable to determine improvements in ways of automating the creating of accounting records.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Some embodiments relate to a method comprising: determining a training dataset for training a model, the training dataset comprising a plurality of example documents, each example document being associated with a document type label; for each example document in the training dataset: providing the example document to a numerical representation generation model to generate a numerical representation of the example; providing the numerical representation of the example document to a document type prediction model or document type attribute predictor to generate a predicted document type; determining a loss value based on a score of the predicted document type and the document type label associated with the example; and adjusting one or more weights of the document type prediction model or document type attribute predictor based the determined loss value; and determining the numerical representation generation model and the document type prediction model or document type attribute predictor to be a trained document type prediction model. The example documents may be accounting records. For example, the document label type may be one of: (i) a bill or invoice; (ii) a credit note; and (iii) a spend money transaction.

In some embodiments, the trained document type prediction model is a neural network. The numerical representation generation model may be or comprise an embedding layer of the neural network.

In some embodiments, the method further comprises generating a corpus of tokens using the plurality of example documents of the training dataset, wherein each token of the corpus is associated with a respective vector. The numerical representation generation model may generate numerical representations of the examples using the corpus.

In some embodiments, the method may further comprise: deploying the trained document type prediction model on an accounting system.

In some embodiments, providing the numerical representation of the example document to a document type prediction model to generate a predicted document type comprises: providing the numerical representation of the example document to recurrent neural network, wherein the recurrent neural network is configured to output a processed numerical representation comprising encoded sequence information about tokens of the example document; and providing the processed numerical representation to the document type prediction model to generate the predicted document type. For example, the recurrent neural network may comprise a gated recurrent unit (GRU), a long short-term memory (LSTM), or a transformer with appropriate positional embeddings.

The document type prediction model or document type attribute predictor may comprise: (i) one or more binary classifiers; (ii) a multi-class classifier; or (iii) one or more binary classifiers and a multi-class classifier.

The document type prediction model may comprise a neural network. The neural network may comprise at least two activation functions, wherein one of the at least two activation functions is applied to each layer of neural network. The at least two activation functions may comprise a first activation function and a second activation function. The first activation function and the second activation function may be applied in an alternating pattern to the layers of the neural network. The first activation function or the second activation function may be a unbounded activation function, such as ReLU, elu, leaky relu, for example. The first activation function or the second activation function may be a bounded activation function, such as tanh, sigmoid, Gaussian, for example. In some embodiments, the first or second activation function may comprise a tanh function and the second or first activation function, respectively, may comprise a rectified linear activation function (ReLU).

Some embodiments relate to a method comprising: determining a candidate document associated with a user of an accounting system; providing the candidate document to a numerical representation generation model to generate a numerical representation of the candidate document; providing the numerical representation to a document type prediction model or document type attribute predictor to generate a predicted document type, wherein the document type prediction model or document type attribute predictor is configured to classify the document as one of a plurality of accounting document types. For example, the plurality of accounting document types may comprise: (i) a bill or invoice; (ii) a credit note; or (iii) a spend money transaction.

The document type prediction model may be trained according to the method of any one of the described methods.

The method may further comprise: responsive to determining that the document type prediction model has predicted the document type of the candidate document as being a bill or invoice: determining a candidate document entity identifier associated with the candidate document; determining entity account identifier associated with the user of the accounting system; and determining whether the candidate document is a bill or an invoice based on a comparison of the candidate document entity identifier and the entity account identifier.

In some embodiments, determining candidate document entity identifier associated with the candidate document may comprise providing the candidate document to an entity determination model configured to predict one or more entity identifiers associated with the document. Determining a candidate document entity identifier associated with the candidate document may comprise determining a document entity identifier associated with the issuer of the candidate document and/or determining a document entity identifier associated with the recipient of the candidate document.

In some embodiments, the method further comprises responsive to determining that the candidate document entity identifier corresponds with the entity account identifier, and that the candidate document entity identifier is the candidate document issuer, determining that the candidate document is an invoice; and responsive to determining that the candidate document entity identifier does not correspond with the entity account identifier, and that the candidate document entity identifier is the candidate document issuer, determining that the candidate document is a bill.

In some embodiments, the method further comprises responsive to determining that the candidate document entity identifier corresponds with the entity account identifier, and that the candidate document entity identifier is the candidate document recipient, determining that the candidate document is a bill; and responsive to determining that the candidate document entity identifier corresponds with the entity account identifier, and that the candidate document entity identifier is the candidate document recipient, determining that the candidate document is an invoice.

In some embodiments, the method further comprises: responsive to determining that the document type prediction model has predicted the document type of the candidate document as being a bill or invoice: determining whether an associated flag of the candidate document has been set, wherein the setting of the flag is indicative of a payment having been made by an entity associated with the user in respect of the candidate document; and responsive to determining that the associated flag has been set, determining that that the candidate record is a bill. The method may further comprise: responsive to determining that the associated flag has been set: determining a candidate document entity identifier associated with the candidate document; determining entity account identifier associated with the user of the accounting system; and determining whether the candidate document is a bill or an invoice based on a comparison of the candidate document entity identifier and the entity account identifier.

In some embodiments, the method further comprises: determining a saved configuration document type for the candidate document in accordance with a saved configuration associated with an entity identifier of the candidate document; and responsive to determining that the document type prediction model has predicted the document type of the candidate document as being other than the saved configuration document type, presenting the user of the accounting system with a suggestion to designate the candidate document type as being that of the determined document type.

Some embodiments relate to a method comprising: determining a candidate document associated with a user of an accounting system; providing the candidate document to a numerical representation generation model to generate a numerical representation of the candidate document; and providing the numerical representation to a document type attribute predictor, wherein the document type attribute predictor is configured to classify the document as being a particular accounting document type or not being the particular accounting document type.

In some embodiments, providing the numerical representation of the candidate document to a document type attribute predictor comprises: providing the numerical representation of the candidate document to recurrent neural network, wherein the recurrent neural network is configured to output a processed numerical representation comprising encoded sequence information about tokens of the candidate document; and providing the processed numerical representation to the document type attribute predictor to generate the predicted document type. The recurrent neural network may comprise a gated recurrent unit (GRU), a long short-term memory (LSTM), or a transformer with appropriate positional embeddings.

The document type attribute predictor may comprise a neural network. The neural network may comprise at least two activation functions, wherein one of the at least two activation functions is applied to each layer of neural network. The at least two activation functions may comprise a first activation function and a second activation function. The first activation function and the second activation function may be applied in an alternating pattern to the layers of the neural network. The first activation function or the second activation function may be a coupling unbounded activation function, such as ReLU, elu, leaky relu, for example. The first activation function or the second activation function may be a bounded activation function, such as tanh, sigmoid, Gaussian, for example. In some embodiments, the first or second activation function may comprise a tanh function and the second or first activation function, respectively, may comprise a rectified linear activation function (ReLU).

In some embodiments, the method further comprises responsive to determining that the document type prediction model has classified the candidate document as not being the particular accounting document type; and providing the numerical representation of the candidate document to a multi-class classifier of the document type attribute predictor to generate a predicted document type, wherein the a multi-class classifier is configured to classify the document as one of a plurality of accounting document types. The plurality of accounting document types of the multi-class classifier may be are other than the particular accounting document type. The document type prediction model is trained according to the method of any one of the described embodiments.

Some embodiments relate to a system comprising: one or more processors; and memory comprising computer executable instructions, which when executed by the one or more processors, cause the system to perform any one of the described methods.

Some embodiments relate to a computer-readable storage medium storing instructions that, when executed by a computer, cause the computer to perform the method of any one of the described methods.

### BRIEF DESCRIPTION OF DRAWINGS

Various ones of the appended drawings merely illustrate example embodiments of the present disclosure and cannot be considered as limiting its scope.

FIG. 1 is a block diagram of a system for facilitating the management of financial records, according to some embodiments;

FIG. 2 is a block diagram illustrating components of a machine-learning (ML) network configured to train a document type prediction model, according to some embodiments;

FIG. 3 is a process flow diagram of a method of training the document type prediction model of FIG. 2, according to some embodiments;

FIG. 4 is a process flow diagram of a method of determining a document type using the document type prediction model generated according to the method of FIG. 3;

FIG. 5 is a block diagram illustrating a document type prediction model comprising a plurality of document type attribute binary classifiers, according to some embodiments; and

FIG. 6 is a block diagram illustrating a document type prediction model comprising a document type attribute binary classifier and a document type attribute multi-class classifier, according to some embodiments.

### DESCRIPTION OF EMBODIMENTS

Embodiments generally relate to methods, systems, and computer-readable media for training document type prediction models, such as accounting document type prediction models. Some embodiments relate to use of document type prediction models to predict or determine document type(s) to assist in accounting record creation.

A well-trained document type prediction model allows for improved determination of types of documents, such as accounting documents including invoices/bills, credit notes, and spend money transactions, and in some embodiments, may facilitate automated, or part automated, accounting record creation, thereby easing the burden on those tasked with creating accounting records.

For example, when uploading documents, including batches of documents, to an accounting system, a document type prediction model capable of readily discerning and labelling the documents according to type may speed up the process, and may mitigate against mistakes being made in mislabeling documents.

For example, in some embodiments, a saved configuration document type label is associated with entity identifiers of documents being uploaded or published to an accounting system and may dictate that any documents issued by or to that entity identifier be labelled as an invoice or bill. A document type prediction model that accurately predicts that the document is actually a credit note, and suggests to a user to override the saved configuration in that instance, may prevent an error being made.

In some embodiments, there is provided a bill/invoice determination module configured to cooperate with the document type prediction model to discriminate or distinguish between a bill and an invoice based on determined entity identifier(s) of the document and entity identifier(s) of a user/entity account with the accounting system. For example, the bill/invoice determination module may comprise an entity determination model, such as a machine learning model configured to determine entity identifiers, such as document issuers (such as suppliers or intended payees) and document recipients (such as intended payers), from text of the documents themselves.

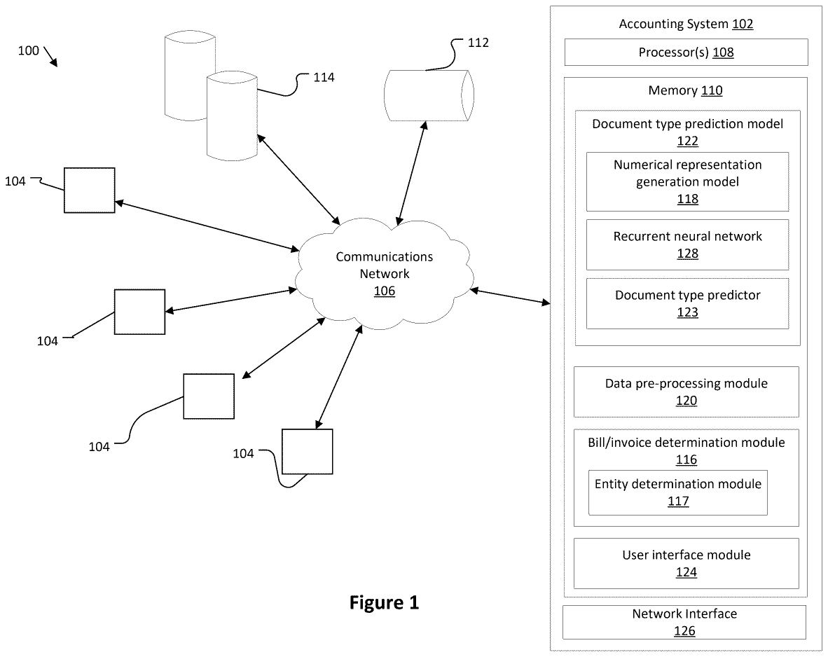

FIG. 1 illustrates a block diagram of a system 100 for facilitating the management of financial and accounting records, according to some embodiments. The system 100 comprises an accounting system 102, which includes the hardware and software necessary to provide accounting software or an accounting software service. In some embodiments, accounting software or an accounting software service provided by the accounting system 102 may be accessible to a client device 104 via a communications network 106, such as the Internet. The accounting system 102 may provide centralised web-based accounting software to a large number of businesses or individuals. For example, the accounting system 102 may be accessible by businesses or individuals using the client device 104 and an internet connection to the accounting system 110. The client device 104 may be an end-user computing device such as a desktop computer, a laptop computer, a mobile device or a tablet device for example.

The accounting system 102 comprises at least one processor 108 and memory 110. The processor(s) 108 may include an integrated electronic circuit that performs the calculations such as a microprocessor, graphic processing unit, for example. In some embodiments, the accounting system 102 may be implemented as a distributed system comprising multiple server systems configured to communicate over a network to provide the functionality of the accounting system 102.

Memory 110 may comprise both volatile and non-volatile memory for storing executable program code, or data. Memory 110 comprises program code which when executed by the processor 108, provides the various computational and data management capabilities of the accounting system 102. The block diagram of FIG. 1 illustrates some of the modules stored in memory 110, which when executed by the processor(s) 102, of the accounting system 102, perform the functionality of the accounting system 102 as described below.

The accounting system 102 comprises a database 112 for storing data used by the accounting system 202 to provide the accounting software services. The database 114 may be implemented using a relational database or a non-relational database or a combination of a relational database and a NoSQL database. The database 112 may be implemented as a distributed system to meet potential scalability requirements of the accounting system 102. The accounting system 102 may access the database directly or via the communications network 206.

The database 112 may comprise transaction data associated with transactions between various entities. At least some of the data in the database 112 is specific to a particular business or entity, and each business or entity using the accounting system 102 has access to data and/or records relating to its own business.

The transaction data may comprise accounting data, such as accounting records of users of the accounting system 102. Accounting records may comprise records regarding transaction-related documents created by a business using the accounting system 102. Each accounting record may have an associated record or document type. For example, such types may include bills (e.g., accounts payable), invoices (e.g. accounts receivable), spend money or purchases, receipts, credit notes, for example. The accounting data of records may include entity data indicative of the entity which issued or supplied the accounting record, typically a supplier of goods and/or services, or of the entity to which the accounting record is or issued or addressed, typically a recipient of goods and/or services.

Entity data may include data regarding business or individuals or entities or contacts that a specific business or entity may transact with. Entity data may comprise name(s) of an entity, contact details such as email and/or phone numbers, a physical address, a web address, entity identification numbers such as a company number, for example. Each entity record may correspond to a real word entity, business or individual that a business may transact with.

Referring again to FIG. 1, memory 110 may comprise a document type prediction model 122. The document type prediction model 122 comprises program code which, when executed by the processor(s) 108, causes the accounting system 102, to determine a document or record type of a financial or accounting record or document. For example, document or record types may include bills, invoices, spend money or purchase, receipts, and/or credit notes.

The document type prediction model 122 comprises a numerical representation generation model 118, for example, to perform feature extraction or vectorization of documents. The numerical representation generation model 118 comprises program code which, when executed by the processor(s) 108, causes the accounting system 102 to generate a numerical representation or vector representation of inputs, such as document or record data, provided thereto. The numerical representation generation model 118 may be configured to provide the generated numerical representation as an input to a document type predictor 123 of the document type prediction model 122. The text or character strings of the records may be converted into tokens or tokenized using a tokenizer such as WordPiece (“Japanese and Korean Voice Search (Schuster et al. 2012)”).

The numerical representation generation model 118 may be configured to receive text of a record, such as an invoice, and provide as an output, a numerical representation of the record. For example, the numerical representation generation model 118 may generate a numerical representation in the form of a vector using a vectorisation technique suitable for natural language processing tasks.

In some embodiments, the numerical representation generation model 118 may be configured to generate numerical representations of document text using a corpus of words or data strings as may be stored in the database 112 accessible to the accounting system 102. For example, the documents and/or records used to generate the corpus (e.g., a learned vocabulary) may comprise invoices/bills, credit notes, receipts/spend money transactions etc. In some embodiments, the corpus may be generated from example documents of a dataset to be used to train the document type predictor 123. The corpus may be a corpus of tokens such as lemmas. Each token of the corpus is associated with a respective vector or word embedding. For example, each vector may have a dimension of 100. The numerical representation generation model 118 may be configured to tokenise or convert the text or character strings of the records into tokens, determine a vector for each token of the record using the corpus, and sum or average the vectors to determine the numerical representation of the record. For example, the numerical representation generation model 118 may comprise a WordPiece encoder (“Japanese and Korean Voice Search (Schuster et al. 2012)”).

In some embodiments, certain n-grams may be collapsed into a single token to better capture the context or meaning of the n-gram. For example, the bigrams “credit note” and “credit card” have specific meanings relating to documents types, and accordingly, these bigrams may each be collapsed into a single representative token.

In embodiments where a token of a candidate record to be converted into a numerical representation does not appear in the corpus, (for example, has not been seen before), numerical representation generation model 118 may be configured to assign the token a vector used for unknown tokens and use that vector in determining or generating the numerical representation for the candidate record. For example, the numerical representation generation model 118 may be configured to swap the token for an “UNKNOWN” token which has a corresponding vector in the corpus.

In some embodiments, a threshold number of tokens is provided to the numerical representation generation model 118. For example, the threshold may be 400 or 500 tokens. Where a record comprises more than the threshold number of tokens, any tokens in excess of the threshold are discarded or not accepted as an input to the numerical representation generation model 118. In cases where a record comprises less than the threshold number of tokens, a vector of the record may be padded, for example, with zero. Determination of a suitable number of tokens may involve balancing accuracy/effectiveness, processing speeds and/or a number and/extent to which records need to be padded. For example, if the threshold is too high, a relatively large number of records may need to be padded, which may impact speed for little or no improved accuracy. On the other hand, if the threshold is too low, too many tokens may be discarded and sufficient information may not be being passed to the document type prediction model 122 to allow for accurate and/or reliable predictions.

In some embodiments, the numerical representation generation model 118 may comprise a trained neural network to generate the word embeddings or vectors corresponding to each token of the transaction data. In some embodiments, the numerical representation generation model 118 may include one or more language models such as the Bidirectional Encoder Representations from Transformers (BERT).

In some embodiments, the document type prediction model 122 comprises a recurrent neural network 128. For example, the recurrent neural network 128 may comprise a plurality of layers disposed between the numerical representation generation model 118 and a document type predictor 123 of the document type prediction model 122 such that the recurrent neural network 128 receives its inputs from the numerical representation generation model 118 and provides its outputs to the document type predictor 123. Recurrent neural networks inherently learn sequential information (order). The recurrent neural network 128 may be configured to encode sequence information or order about tokens of the document. The recurrent neural network 128 may be configured to encode positional information about the tokens, and/or to learn order dependence in sequences. In some embodiments, the recurrent neural network 128 may include an attention layer to thereby pay attention to specific tokens. In classifying transaction or financial documents, the sequence and/or ordering of words may be important. For example, in determining whether to classify a document as a credit note, the occurrence of the sequence “credit note” in the document would be important, and would want to be distinguished from the occurrence of the sequence “credit card”.

The recurrent neural network 128 may comprise a gated recurrent unit (GRU), a long short-term memory (LSTM), or a transformer with appropriate positional embeddings. For example, the last two layers of the pre-trained transformer BERT may be fine-tuned to perform the encoding of token positional information (“small BERT”). Such a transformer with appropriate positional embeddings has been found to perform well. However, it is not trained end-to-end and may slow in making inferences. It also uses nine times more parameters than a GRU with diminishing returns on performance. A GRU may be relatively more straight-forward to productionise and deploy than for example, a transformer with appropriate positional embeddings. Performance metrics of a document type prediction model 122 comprising a GRU and a document type prediction model 122 comprising a small Bert transformer are discussed in more detail below.

The document type prediction model 122 comprises the document type predictor 123 or prediction model configured to process a numerical representation of a candidate record to determine one or more suggested or recommended document types for the candidate record. The document type prediction model 122 (or document type predictor 123 of the document type prediction model 122) may be configured to generate a confidence score associated with each respective suggested document type.

In some embodiments, the attribute predictor 123 may be a multi-class classifier. For example, the suggested or recommended document type(s) may be selected from a set of possible document types. In some embodiments, the set of documents types comprises (i) bill/invoice; (ii) credit note; (iii) spend money transaction. For example, the attribute predictor 123 may comprise a matrix of size [embedding dimension, no. of classes], wherein the x values comprise weights to be adjusted as the attribute predictor 123 is trained. For example, the matrix have a size [3, 100]. The trained document type prediction model 122 is configured to cause a numerical representation of a candidate record as generated by the numerical representation generation model 118 (and in some embodiments, processed by the recurrent neural network 128) to be multiplied by the matrix of the attribute predictor 123 to generate confidence values or scores for each of the classes of document types.

In some embodiments, the attribute predictor 123 may be a binary classifier. For example, the trained document type prediction model 122 may configured to cause a numerical representation of a candidate record as generated by the numerical representation generation model 118 (and in some embodiments, processed by the recurrent neural network 128) to be multiplied by a matrix of the attribute predictor 123 to a generate confidence values or scores for the document type, which may be indicative of whether or not the candidate document is a document of the type of the binary classifier.

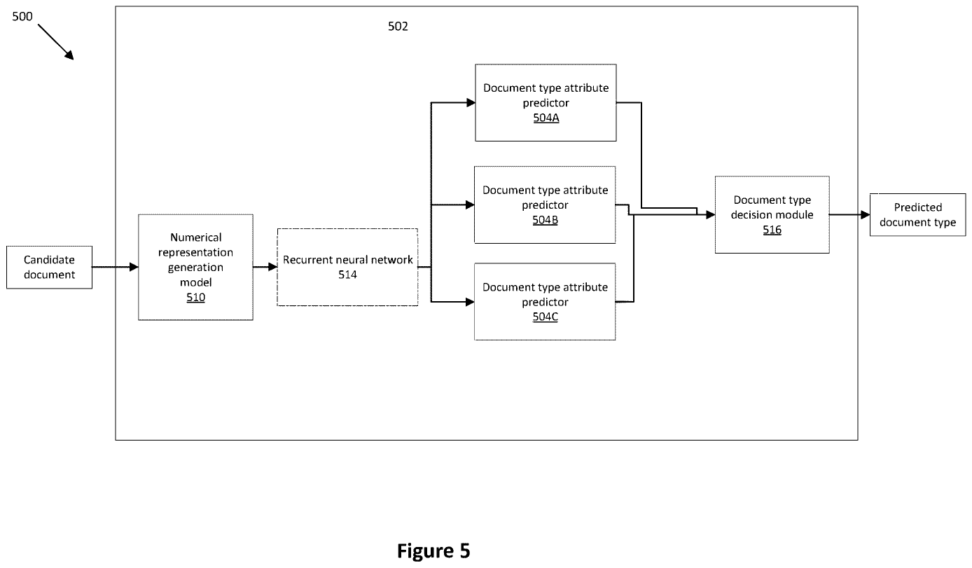

The attribute predictor 123 may be configured to classify a record as being a bill/invoice or not a bill/invoice. The attribute predictor 123 may be configured to classify a record as being a credit note or not a credit note. The attribute predictor 123 may be configured to classify a record as being a spend money transaction or not being a spend money transaction. In some embodiments, the attribute predictor 123 may comprise multiple binary classifiers 504A to 504C of transaction document type prediction model 502 illustrated in FIG. 5. The numerical representation generation model 510 and the optional recurrent neural network 514 may substantially correspond with numerical representation generation model 118 and recurrent neural network 128, respectively. Each of the binary classifiers 504A to 504C may be configured to classify a document as belonging or not belonging to a different document type. In such an embodiments, the document prediction model 502 may further comprise a document type decision module 516 to determine from the outputs of the binary classifiers 504A to 504C which document type the document should be appropriately labelled with. For example, document type decision module 516 may determine the document type with the highest predictor score (for example, probability as may be calculated by a softmax function of the respective binary classifiers 504A to 504C) to be the document type of the candidate document.

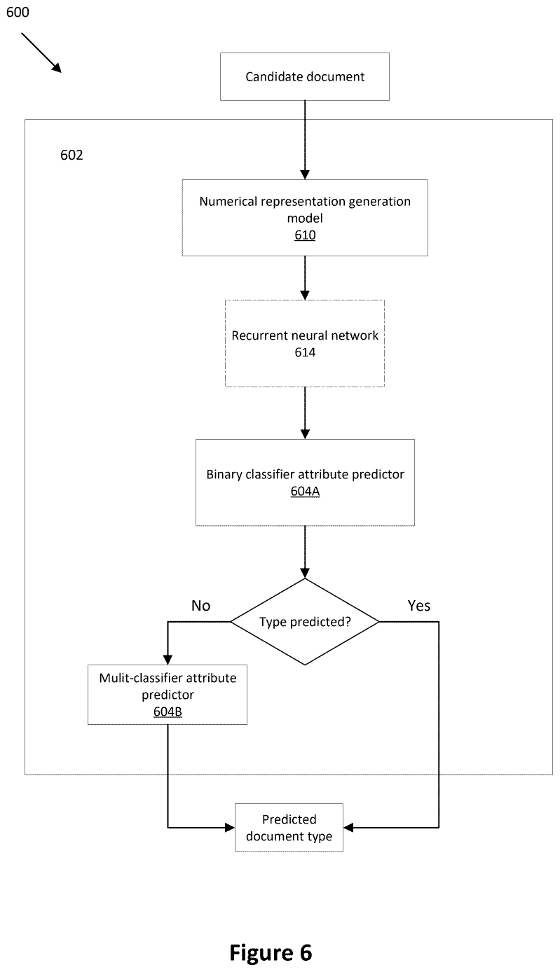

In some embodiments, the attribute predictor 123 may comprise a binary classifier 604A and a multi-class classifier 604B of transaction document type prediction model 602 illustrated in in FIG. 6. The numerical representation generation model 610 and the optional recurrent neural network 614 may substantially correspond with numerical representation generation model 118 and recurrent neural network 128 (described below), respectively. The binary classifier 604A may be configured to classify a document as being or not being a first type of document. The first type of document may be any one of, such as any one of: (i) bill/invoice; (ii) credit note; (iii) spend money transaction. The multi-class classifier 604B may be configured to classify a document as one of a plurality of document types, such as any one of: (i) bill/invoice; (ii) credit note; (iii) spend money transaction. The document type of the binary classifier may different to the documents types of the multi-class classifier. The transaction document type prediction model 602 may comprise a decision node or module 618 to determine whether or not the multi-class classifier 604B is required to classify the document. In some embodiments, the candidate document is first provided to the binary classifier 604A and where the binary classifier 604A classifies the candidate document as being the document type of the binary classifier (e.g. a first document type). If the binary classifier 604A classifies the document as being the first document type, the decision module 618 determines that the predicted document type is the first document type. If the binary classifier 604A classifies the candidate document as not being the first type of document, the decision module 618 determines that the multi-class classifier 604B is required. The candidate document (the numerical representation thereof, as for example, may be provided by the numerical representation generation model 610 or the recurrent neural network 614) may be provided to the multi-class classifier 604B to determine which of a plurality of document types of the multi-class classifier the candidate document should be labelled as. The output of the multi-class classifier 604B then determines the predicted document type.

In some embodiments, the document type prediction model 122 may comprise a feedforward neural network, or a convolutional neural network, or a recurrent neural network or a transformer based neural network to process the candidate record.

The attribute predictor 123 of the document type prediction model 122 may comprise one or more activation functions to determine whether a neuron of the neural network of the attribute predictor 123 will be activated or not. In some embodiments, the attribute predictor 123 uses two or more different types of activation functions. The two or more activation functions may be used in an alternating pattern. The two or more activation functions may complement each other. The neural network may couple an unbounded activation function with a bounded activation function. For example, where two different activation functions are used, they may be used alternatively, such that the activation function used for every odd layer of the neural network is a first activation function, and the activation function used for every even layer of the neural network is the second activation function. The first activation function or the second activation function may be a coupling unbounded activation function, such as ReLU, elu, leaky relu, for example. The first activation function or the second activation function may be a bounded activation function, such as tanh, sigmoid, Gaussian, for example. For example, the first activation function may be a tanh function, and the second activation function may be a rectified linear activation function (ReLU), or vice versa. A ReLU activation function returns an unchanged value or a zero and accordingly, gradients may disappear, or may get very large, especially where large numbers of numbers are being handled. Because a ReLU function passes direct gradients, it tends to be good for convergence, and relatively fast processing speeds. A tanh function scales gradients into a range from −1 to 1, and thereby produces much smaller gradients. The tanh function is more complicated and typically unstabilising. The ReLU function is typically not unstabilising. Therefore, by alternating these two activation functions, a more stable derivative is passed through the network.

Memory 110 may comprise a data pre-processing module 120 including program code which, when executed by the processor(s) 102, causes the accounting system 102 to perform data pre-processing, which may improve the efficiency and/or accuracy of the operations performed by the accounting system 102. Pre-processing operations may include operations that are performed on records before they are provided to the numerical representation generation model 118. Pre-processing operations may include removal of semantically irrelevant characters or strings in records. Semantically irrelevant characters or strings may include characters or strings that do not have meaningful information relevant to document type determination.

Pre-processing of records may also include replacement of a pre-defined pattern of characters or strings with a pre-defined replacement token that better captures the semantic meaning of the replaced pre-defined pattern of characters or strings. The pre-defined pattern of characters or strings for replacement may be identified using one or more regular expressions provided in the pre-processing module 120. The replacement of a pre-defined pattern of characters or strings with a pre-defined replacement token may bring about greater consistency in records originating from distinct sources and may improve the performance and/or accuracy of the operations performed by the document type prediction model 122 of the accounting system 102.

Memory 110 may also comprise a user interface module 124 to allow a user to interact with the accounting system 102. For example, the user interface module 124 may allow users to upload or publish accounting documents to their user account with the accounting system 102. For example, by uploading or publishing a document such as a bill, a corresponding transaction is created in the accounting system 102. In some embodiments, details about the transaction may be extracted or determined from the document. For example, in some embodiments, the document type, such as a bill/invoice, a credit note or a spend money transaction/receipt may be predicted by the document type prediction model 122. The document type prediction model 122 may be configured to automatically populate a document type field of the newly created transaction.

In some embodiments, the document type prediction model 122 may suggest the predicted document type to the user. For example, if a user has already pre-filled in the document type field with a different document type, or the accounting system 102 has automatically pre-filled in accordance with a saved configuration for an issuer of the document (e.g. a supplier issuing a bill), the document type prediction model 122 may suggest a different document type if it has predicted a different document type for the document. Such a situation may occur where the saved configuration or settings indicate that the document type field for a particular document issuer should be populated with “invoice”, but the document is actually a “credit note”, which would tend to occur more rarely.

Memory 110 may also comprise a bill/invoice determination module 116 including program code which, when executed by the processor(s) 102, causes the accounting system 102 to distinguish between a bill and an invoice, from the perspective of the entity or user account of the accounting system 102. For example, although the document type prediction model 122 may be able to determine whether a document is a spend money/receipt, a credit note or a bill/invoice, it is not configured to differentiate between a bill and an invoice. This is because a document is classified as a bill or an invoice depending on who the issuing party or supplier is relative to the user (or entity associated with the user). If the issuing party is the entity using the accounting system 202, then it is an invoice-accounts receivable. However, if the issuing party is some other entity, and the entity using the accounting system 102 is the party to whom the document has been issued (i.e., the recipient), then the document is a bill-accounts payable.

In some embodiments, where the document has been predicted to be a bill or an invoice, the bill/invoice determination module 116 may be configured to determine an entity attribute of the document. For example, the entity attribute may be an identifier of the entity that issued or generated the document (“the supplier”) or an identifier of the entity to which the document was issued or addressed (“the recipient”). The bill/invoice determination module 116 may comprise an entity determination module 117 configured to determine the supplier entity and/or the recipient entity associated with a document. In some embodiments, the entity determination module 117 may prompt the user to identify the supplier entity and/or the recipient entity. In some embodiments, the entity determination module 117 may be configured to infer or otherwise automatically determine the supplier entity and/or the recipient entity from the document. For example, the entity determination module 117 may be configured in accordance with the teachings disclosed in International (PCT) Patent Application No. PCT/NZ2021/050133, entitled “Systems and methods for generating document numerical representations” filed on 19 Aug. 2021.

The bill/invoice determination module 116 may compare the determined supplier or recipient entity identifier with the entity identifier of the entity or user using the accounting system 102 (for example, the entity associated with the user logged into an account), to thereby determine whether the document is an invoice or a bill. If the determined supplier is the entity using the accounting system 102, then the document is an invoice; otherwise it is a bill. Similarly, if the determined recipient is the entity using the accounting system 102, then the document is a bill; otherwise it is an invoice.

In some embodiments, the bill/invoice determination module 116 may be configured to determine whether the candidate record (bill or invoice) has been marked or flagged as having been paid. This may be achieved by the bill/invoice determination module 116 querying whether an associated flag for the record has been set, such as a flag indicative of whether the record has been paid (e.g., the “mark as paid” flag). For example, the user may set the flag using the user interface 124. Responsive to the bill/invoice determination module 116 determining that the associated flag has been set indicating that payment has been made (for example by the user or on behalf of the organization/entity associated with the user), the bill/invoice determination module 116 may determine that the candidate record is a bill. Responsive to the bill/invoice determination module 116 determining that the associated flag has not been set indicating that payment has not been made, the bill/invoice determination module 116 may determine that the candidate record is an invoice. However, in some embodiments, the user may not activate the flag despite the fact that the record is a bill. Accordingly, in some embodiments, the bill/invoice determination module 116 determines that the candidate record is a bill if the flag is set, but if the flag is not set, the bill/invoice determination module 116 may apply a different strategy, such as determining the supplier and/recipient of the candidate record as described above, in order to determine if the candidate record is a bill or an invoice.

The accounting system 102 further comprises a network interface 126 to facilitate communications with components of the system 100 across the communications network 106, such as the computing device(s) 104, database 112 and/or other servers, including financial institute or banking server 114. The network interface 126 may comprise a combination of network interface hardware and network interface software suitable for establishing, maintaining and facilitating communication over a relevant communication channel.

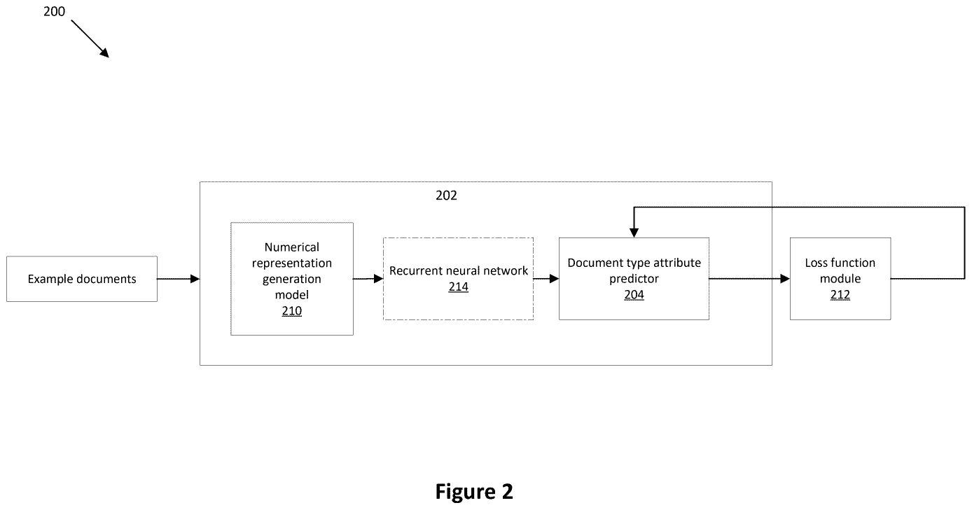

Referring now to FIG. 2, there is illustrated a schematic of a ML network 200 comprising components used to train the document type prediction model 122. In some embodiments, the ML network 200 may be deployed on, or be otherwise accessible to the accounting system 102.

As illustrated in FIG. 2, the ML network 200 comprises a transaction document type prediction model 202. In some embodiments, the document type prediction model 202 comprises a numerical representation generation model 210 and a document type predictor 204.

The document type attribute predictor 204 may be multi-class classifier. For example, the document type attribute predictor 204 may be configured to classify an example or candidate document (or numerical representation thereof) as being associated with a document type of a plurality of (or a set of) document types. The document type attribute predictor 204 may be a binary classifier. For example, the document type attribute predictor 204 may be configured to classify an example or candidate document (or numerical representation thereof) as being associated with a particular document type or not being associated with that particular type. In some embodiments, the document type attribute predictor 204 may comprise multiple binary classifiers, each associated with a different document type of the plurality of (or a set of) document types.

The document type prediction model 202 may be trained using a training dataset of example documents, which may be previously labelled documents, with each document associated or labelled with at least one document type.

For example, in one embodiment, the training dataset comprises a balanced dataset, with equal numbers of documents representing each document type. For example, in one embodiment, a dataset of 13,500 documents was used, with 4,500 documents labelled as being bills/invoices, 4,500 documents labelled as being credit notes, and 4,500 documents labelled as being spend money transactions. The documents were in image format and Optical Character Recognition (OCR) processing was applied to the images to generate text formats of the documents. In some embodiments, the documents of the training data set are used to generate the corpus of lemmas or tokens stored in the database 112 accessible to the accounting system 102, for example, using tokenization software, such as WordPiece.

In some embodiments, the training dataset comprises an unbalanced dataset, with unequal numbers of documents representing at least one of the document types relative to the others. For example, in one embodiment, less than 2% (e.g. 1.6%) of the documents in the dataset were labelled as credit notes. To address or mitigate negative impacts of the unbalanced training set on the attribute predictor 123, a Focal Loss function or a cross-entropy loss function with class weighting may be used by the loss function module 212 when training the attribute predictor 123, as discussed in more detail below.

In some embodiment, the document type attribute predictor 204 is configured to receive, from the numerical representation generation model 210 of the document type prediction model 202 (which may be similar to or the same as numerical representation generation model 118 of FIG. 1), numerical representations of the example documents. In some embodiments, the document type attribute predictor 204 is configured to receive, from the recurrent neural network 214 (which may be similar to or the same as recurrent neural network 128 of FIG. 1) of the document type prediction model 202, processed numerical representations of the example documents.

The document type attribute predictor 204 is configured to generate a predicted document type based on the received numerical representation of an example document.

In some embodiments, where the document type predictor 204 is a multi-class classifier, it is configured to determine a score indicative of the example document being associated with, or belonging to, each document type set. The scores may be converted into probability values using a softmax function layer. The document type from the classification set having the highest probability level is considered as being the predicted attribute label.

In some embodiments, where the document type predictor 204 is or comprises a binary classifier, it is configured to determine a score indicative of the example document being associated with, or belonging to, a particular document type, such as a credit note. The score may be converted into probability value using a softmax function layer. If the score or probability value is greater than a threshold value, such as 0.5, the example document is considered or predicted as being the document type of the classifier.

In some embodiments, the loss function module 212 of the ML network 200 may determine a loss function value based on the predicted document type and the respective actual document type label of the example. The loss function module 212 may be configured to determine a loss value using categorical cross-entropy loss function, for example. The loss function module 212 may be configured to determine a loss value using a Focal Loss function. The loss function module 212 may be configured to determine a loss value using a cross-entropy loss function with class weighting.

The loss value is then used to adjust or fine-tune the weights or parameters of the document type attribute predictor 204 being trained. For example, a backpropagation algorithm may be used to iteratively adjust the weight(s) of the document type attribute predictor 204 to obtain the trained document type prediction model 122, 202.

For each example document of the training dataset, the loss value is determined and the weight(s) of the document type prediction model 122 are adjusted or fine-tuned as required, to thereby produce the trained document type prediction model 202 of FIG. 2.

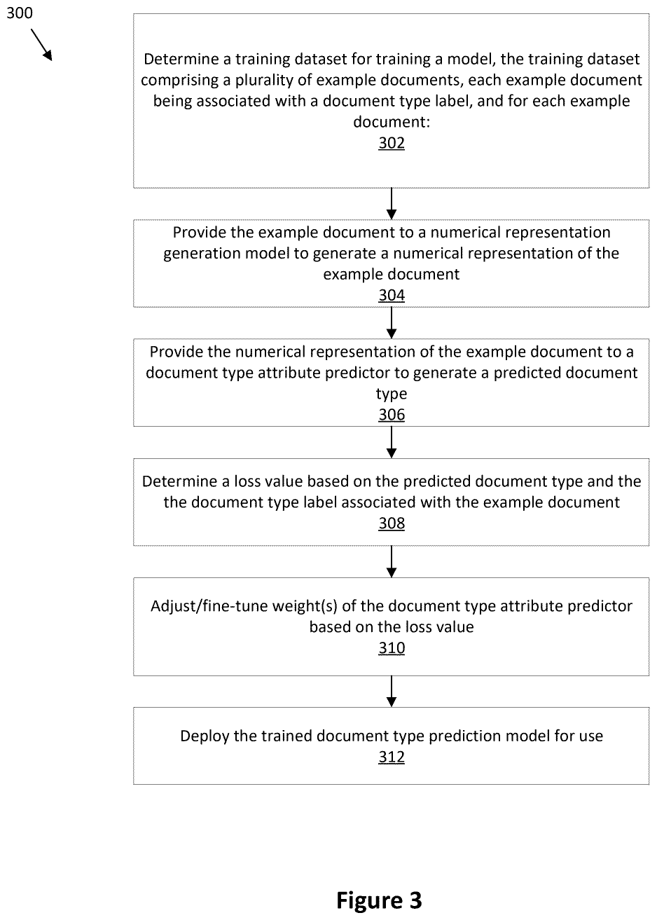

FIG. 3 is a process flow diagram of a method of training the document type prediction model 122 of the accounting system 102, according to some embodiments. In some embodiments, the method 300 may be performed by the processor(s) 108 of the accounting system 102 executing modules and/or models, such as the ML network 200 of FIG. 2A as may be stored in memory 110. In other embodiments, the method 300 may be performed by one or more processor(s) (not shown) of a different, or remote system (not shown) executing computer program code, such as the ML network 200 of FIG. 2 stored in memory (not shown) accessible thereto. In the latter embodiment, once trained, the document type prediction model 122 may be deployed on the accounting system 102 for use.

At 302, the accounting system 102, or other system (not shown), determines a dataset or batch of training data for training a document type prediction model 122. The training data comprises a plurality of example documents. Each example document is associated with at least one document type label of a set of labels, such as invoice/bill, receipt/spend money and/or credit note.

The accounting system 102, or other system (not shown), may be configured to perform steps 304 to 310 for each of the example documents of the training set to adjust, or iteratively adjust, or fine-tune weight(s) or parameter(s) of the document type prediction model 122 being trained.

At 304, the accounting system 102, or other system (not shown), provides the example document to the numerical representation generation model 210 of the document type prediction model 122 of the ML network 200 to generate a numerical representation of the example document. In some embodiments, the document is tokenized before providing it to the numerical representation generation model 210. The numerical representation generation model 210 may be configured to generate a numerical representation of the example document in a manner similar to that described above with respect to the numerical representation generation model 118.

At 306, the numerical representation of the example document is provided to the document type attribute predictor 204, which generates a predicted document type for the example document. In some embodiments, the numerical representation generation model 210 provides the numerical representation of the example document to the recurrent neural network 214, and the recurrent neural network 214 provides a processed numerical representation of the example document to the document type attribute predictor 204. For example, the processed numerical representation of the example document may comprise encoded sequence information about tokens of the example document.

At 308, the loss function module 212 of the ML network 200 determines a loss value based on the predicted document type and the document type label associated with the example document.

At 310, the loss function module 212 adjusts (or causes adjustment of) the weight(s) of the document type attribute predictor 204 of the document type prediction model 202 based on the loss value. For example, the loss function module 212 may be based on a categorical cross-entropy loss function, a Focal Loss function or cross-entropy loss function with class weighting.

In some embodiments, the cross-entropy loss function with class weighting is used to address or lessen the impact of unbalanced training datasets on the model being trained. Where the number examples of one document type in the training dataset are different to the numbers of examples of other document types, the training dataset may be considered unbalanced. For example, the issuance of credit notes by a businesses is typically much rarer than the issuance of invoices and accordingly a number of examples of credit notes in a dataset extracted from an accounting system 102 may be significantly less than the number of examples of invoices/bills and/or spend money transactions. When training attribute predictor 123 of the document type prediction model 122, imbalances in the training dataset may be offset somewhat by down-weighting errors in the over represented class or type. In other words, the loss function module 212 may be configured to weight more-heavily errors in mislabeling documents of a type that is well or over represented in the training dataset. This is in contrast to what might be perceived as a more intuitive approach of up-weighting or more-heavily weighting errors in mislabeling documents of a type that is not well or underrepresented in the training dataset; that is penalizing heavily for the rarest type, the one you don't want the model to make a mistake in predicting. This is a typical approach, as for example explained in TensorFlow Core tutorial on classification on imbalanced data (https://www tensorflow.org/tutorials/structured data/imbalanced data). Instead, by weighting more-heavily errors in mislabeling documents of a type that is well or over represented in the training dataset, the document type prediction model 202 is less likely to predict a most obvious or most represented type. The loss function module 212 may be configured to more heavily penalise the document type attribute prediction model 204 for false negatives than for false positives, in one or more classes or types of documents, such as those under-represented in the training dataset.

For example, where the document type attribute predictor 204 is a binary classifier configured to determine whether a document is a credit note or not a credit note, and the training dataset used to train the document type attribute predictor 204 comprises an under-represented number of examples of credit notes, the loss function module 212 may use or apply a cross-entropy loss function with class weighting to train the document type attribute predictor 204. The loss function module 212 may be configured to more heavily weight errors that are false negatives (for example, situations where the document type attribute predictor 204 predicts a document to be an invoice but it is labelled as a credit note) than errors that are false positives (for example, situations where the document type attribute predictor 204 predicts a document to be a credit note but it is labelled as an invoice).

Once the examples of the training dataset have been processed, the document type prediction model 202 may be considered trained, and the document type prediction model 202 may be deployed for use, for example, as document type prediction model 122 on the accounting system 102.

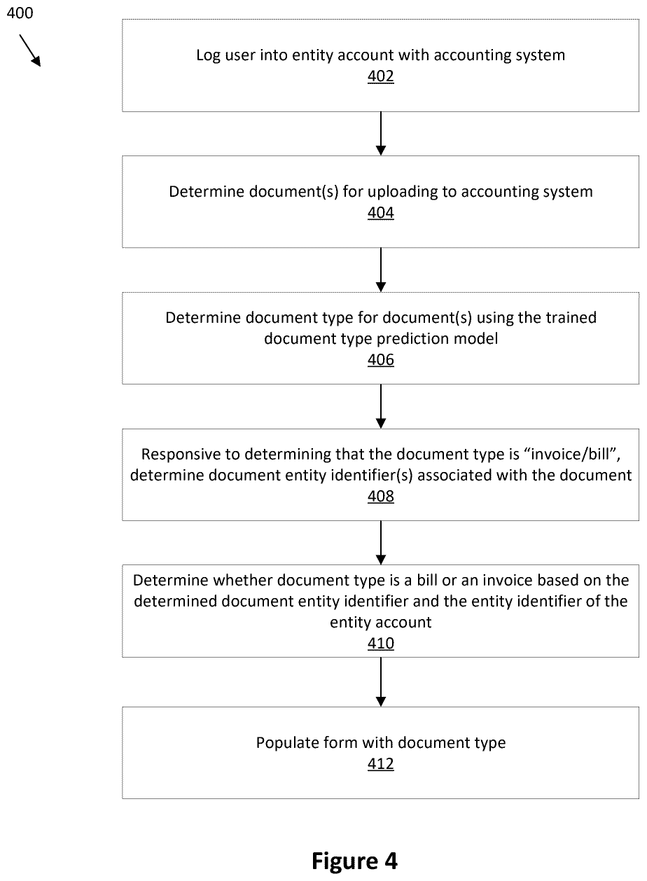

Referring now to FIG. 4, is a process flow diagram of a method of using the document type prediction model 122 of the accounting system 102, according to some embodiments.

At 402, the accounting system 102 logs a user into an entity account, for example, in response to receiving a log in request, and any relevant information, such as a username and password.

At 404, the accounting system 102 determines one or more documents for uploading or publishing to the accounting system 102 by the user. For example, the user may select a user option to upload document(s), such as invoices, bills, receipts, credit notes, spend money transactions, receipt etc. to the entity account with the accounting system 102.

At 406, the accounting system 102 automatically determines a document type of the document being uploaded (or the respective document types of the documents being uploaded if multiple documents are being uploaded together). In some embodiments, the accounting system 102 provides the uploaded document(s) to the trained document type prediction model 122 to determine or predict the document type of the respective document.

In some embodiments, at 408 and 410, where the document type prediction model 122 determines that a candidate document is a type “bill or invoice”, the accounting system 102 may be configured to determine whether the document is a bill or invoice. For example, in some embodiments, at 408, the accounting system 102 may determine an entity identifier associated with the document, such as the supplier and/or recipient of the document. The accounting system 102 may automatically determine the entity identifier, for example, using entity determination module 117.

At 410, the account system 102 may determine whether the document type is an invoice or a bill based on the determined document entity identifier and an entity identifier associated with the entity account being accessed by the logged in user. For example, the bill/invoice determination module 116 may compare the determined supplier or recipient entity identifier with the entity identifier of the entity or user using the accounting system 102 (for example, the entity associated with the user logged into an account), to thereby determine whether the document is an invoice or a bill. Responsive to the determined supplier being the entity using the accounting system 102, the bill/invoice determination module 116 determines that the document is an invoice; otherwise it is determined as being a bill. Similarly, if the determined recipient is the entity using the accounting system 102, then the bill/invoice determination module 116 determines that the document is a bill; otherwise it is determined as being an invoice.

At 412, the account system 102 (for example, the document type prediction model 122 or the bill/invoice determination module 116) may populate a document type field of the relevant form with an indication of whether the document type is a bill or an invoice. The upload form may be presented to the user on a GUI of the user interface 124.

In some embodiments, in response to determining that the document type field of the form has been populated according to a saved configuration document type for the account entity identifier or the document entity identifier, and the predicted document type determined by the document type prediction model 122 differs from the saved configuration document, the accounting system 102 may be configured to present the determined document type to the user, for example via the user interface 124, to allow the user to select whether the document type field should instead be populated with the determined document type.

The following tables present performance metrics of two trained document type prediction models. The first document type prediction model 122 (“Model 1”) comprises the numerical representation generation model 118, a GRU and a binary classifier attribute predictor 123 configured to classify a candidate document as either a credit note or not a credit note. The second document type prediction model 122 (“Model 2”) comprises the numerical representation generation model 118, a small BERT transformer with appropriate positional embeddings and a binary classifier attribute predictor 123 configured to classify a candidate document as either a credit note or not a credit note. Both were tested using a first test dataset of 2.7 million examples (with 38,481 of those being credit notes), and a second testing set of about 4.5 million examples (with 69,216 of those being credit notes). The threshold (@0.5, @0.55 or @0.85 in the examples below) is indicative of the certainty of the model in making the prediction. For example, @0.85 means that the model predicted the results with at least a 0.85 confidence/probability value. The metric F1 is relates to an F-score or F-measure, which is indicative of the accuracy of the model, precision is the percentage of predicted positives that were correctly classified, and recall is the percentage of actual positives that were correctly classified.

The following results were achieved:

TABLE
Model 1 results

| Measures | Testing set 1 | Testing Set 2 |
|---|---|---|
| F1 | 0.721 @ 0.5 | 0724 @ 0.5 |
| Precision | 0.77 @ 0.85 | 0.97 @ 0.85 |
| Recall | 0.788 @ 0.85 | 0.73 @ 0.85 |

TABLE
Model 2 results

| Measures | Testing set 1 | Testing Set 2 |
|---|---|---|
| F1 | 0.783 @ 0.5 | 0.819 @ 0.5 |
| Precision | 0.783 @ 0.5 \| 0.795 | 0.971 @ 0.5 \| 1.00 |
| | @ 0.55 | @ 0.55 |
| Recall | 0.798 @ 0.5 \| 0.773 | 0.708 @ 0.5 \| 0.667 |
| | @ 0.55 | @ 0.55 |

Further testing has been performed on Model 1. From a test dataset of 2.7 million documents, with 38,481 of those being credit notes, Model 1 achieved 78% precision and 77% recall at a threshold of 0.9. From a test dataset of 4.5 million documents, with 69,216 of those being credit notes, Model 1 achieved 84% precision and 73% recall at a threshold of 0.9. From a test dataset of 924,850 million documents, with 14,714 of those being credit notes, Model 1 achieved 83% precision and 76% recall at a threshold of 0.9.

Performance metrics were also recorded for a third trained document type prediction model (Model 3) comprising the numerical representation generation model 118, and a multi-class classifier attribute predictor 123 configured to classify a candidate document as one of five different document types. From a test dataset of 2.7 million documents, Model 3 achieved 17% precision and 91% recall.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method comprising:
determining a training dataset for training a model, the training dataset comprising a plurality of example documents, each example document being associated with a document type label;
for each example document in the training dataset:
providing the example document to a numerical representation generation model to generate a numerical representation of an example;
providing the numerical representation of the example document to a document type attribute predictor to generate a predicted document type;
determining a loss value based on a score of the predicted document type and the document type label associated with the example; and
adjusting one or more weights of the document type attribute predictor based the determined loss value; and
determining the numerical representation generation model and the document type attribute predictor to be a trained document type prediction model.

2. The method of claim 1, wherein the document type label is one of: (i) a bill or invoice; (ii) a credit note; and (iii) a spend money transaction.

3. The method of claim 1, wherein the trained document type prediction model is a neural network.

4. The method of claim 3, wherein the numerical representation generation model comprises an embedding layer of the neural network.

5. The method of claim 4, wherein the example documents are accounting records.

6. The method of claim 1, wherein the example documents are tokenised example documents.

7. The method of claim 1, further comprising generating a corpus of tokens using the plurality of example documents of the training dataset, wherein each token of the corpus is associated with a respective vector.

8. The method of claim 7, wherein the numerical representation generation model generates numerical representations of the examples using the corpus.

9. The method of claim 1, further comprising:
deploying the trained document type prediction model on an accounting system.

10. The method of claim 1, wherein providing the numerical representation of the example document to a document type attribute predictor to generate a predicted document type comprises:
providing the numerical representation of the example document to recurrent neural network, wherein the recurrent neural network is configured to output a processed numerical representation comprising encoded sequence information about tokens of the example document; and
providing the processed numerical representation to the document type attribute predictor to generate the predicted document type.

11. The method of claim 10, wherein the recurrent neural network comprises a gated recurrent unit (GRU), a long short-term memory (LSTM), or a transformer with appropriate positional embeddings.

12. The method of claim 1, wherein the trained document type prediction model comprises: (i) one or more binary classifiers; (ii) a multi-class classifier; or (iii) one or more binary classifiers and a multi-class classifier.

13. The method of claim 1, wherein the trained document type prediction model comprises a neural network and the neural network comprises at least two activation functions, and wherein one of the at least two activation functions is applied to each layer of the neural network.

14. The method of claim 13, wherein the at least two activation functions comprise a first activation function and a second activation function, and the first activation function and the second activation function are applied in an alternating pattern to layers of the neural network.

15. The method of claim 14, wherein the first or second activation function comprises an unbounded activation function and the second or first activation function comprises a bounded activation function.

16.-35. (canceled)

36. A system comprising:
one or more processors; and
memory comprising computer executable instructions, which when executed by the one or more processors, cause the system to perform operations including:
determining a training dataset for training a model, the training dataset comprising a plurality of example documents, each example document being associated with a document type label;
for each example document in the training dataset:
providing the example document to a numerical representation generation model to generate a numerical representation of an example;
providing the numerical representation of the example document to a document type attribute predictor to generate a predicted document type;
determining a loss value based on a score of the predicted document type and the document type label associated with the example; and
adjusting one or more weights of the document type attribute predictor based the determined loss value; and
determining the numerical representation generation model and the document type attribute predictor to be a trained document type prediction model.

37. A non-transitory computer-readable storage medium storing instructions that, when executed by a computer, cause the computer to perform operations including:
determining a training dataset for training a model, the training dataset comprising a plurality of example documents, each example document being associated with a document type label;
for each example document in the training dataset:
providing the example document to a numerical representation generation model to generate a numerical representation of an example;
providing the numerical representation of the example document to a document type attribute predictor to generate a predicted document type;
determining a loss value based on a score of the predicted document type and the document type label associated with the example; and
adjusting one or more weights of the document type attribute predictor based the determined loss value; and
determining the numerical representation generation model and the document type attribute predictor to be a trained document type prediction model.

38. The system of claim 36, wherein the trained document type prediction model comprises a neural network and the neural network comprises at least two activation functions, and wherein one of the at least two activation functions is applied to each layer of the of neural network.

39. The system of claim 38, wherein the at least two activation functions comprise a first activation function and a second activation function, and the first activation function and the second activation function are applied in an alternating pattern to layers of the neural network.

40. The non-transitory computer-readable storage medium of claim 37, wherein the trained document type prediction model comprises a neural network and the neural network comprises at least two activation functions, and wherein one of the at least two activation functions is applied to each layer of the neural network.
